(19) United States
(12) Patent Application Publication
(10) Pub. No.: US 2010/0112320 A1
(43) Pub. Date: May 6, 2010

(54) PAPER PRODUCT WITH VISUAL SIGNALING UPON USE

(76) Inventors: Ward William Ostendorf, West Chester, OH (US); Rebecca Howland Spitzer, Burlington, KY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/614,599

(22) Filed: Nov. 9, 2009

Related U.S. Application Data
(63) Continuation-in-part of application No. 12/116,288, filed on May 7, 2008.

(51) Int. Cl. B32B 7/02

(52) U.S. Cl. 428/218

(57) ABSTRACT

A fibrous structure product having a continuous first densified region; a plurality of discrete pillow regions having an area of from about 0.002 in² to about 0.015 in²; and at least some of the plurality of the discrete pillow regions have an inner perimeter forming a boundary defining at least one discrete second densified region comprising an area of from about 5% to about 75% of the area of the discrete pillow region, is provided.

In another embodiment, a fibrous structure product is provided having a continuous first densified region; a plurality of discrete pillow regions having an area of from about 0.002 in² to about 0.015 in²; and at least some of the plurality of the discrete pillow regions have an inner perimeter forming a boundary defining at least one discrete second densified region comprising an area of from about 5% to about 75% of the area of the discrete pillow region.

### CROSS REFERENCE TO RELATED APPLICATION

This application is a continuation-in-part of U.S. application Ser. No. 12/116,288 filed May 7, 2008.

### FIELD OF THE INVENTION

The present invention relates to fibrous structure products, more specifically multi-ply fibrous structure products having an enhanced appearance upon wetting.

### BACKGROUND OF THE INVENTION

Cellulosic fibrous structures are a staple of everyday life. Cellulosic fibrous structures are used as consumer products for paper towels, toilet tissue, facial tissue, napkins, and the like. The large demand for such paper products has created a demand for improved versions of the products and the methods of their manufacture.

Some consumers prefer cellulosic fibrous structure products that have a softer, more three-dimensional, quilted appearance. Many consumers also prefer fibrous structure products that signal that the product is performing according to its intended use. For example, certain paper towel-type products that change color when the paper towel product comes into contact with bacteria, are available. Such attributes, however, must be provided without sacrificing the other desired functional qualities of the product such as softness, absorbency, drape, flexibility, and bond strength between the plies.

Paper towels may rely on a thick and quilted appearance to provide the consumer with an indication of the absorbency of the product. Many fibrous structure product manufacturers use techniques such as embossing to impart a quilted appearance onto a fibrous structure product and to improve the physical attributes of the product. For example, embossing may provide the surface of the cellulosic fibrous structure with a highly desirable quilted appearance. Embossing may also have a positive impact on the functional attributes of absorbency, compressibility, and bulk of the cellulosic fibrous structure. However, upon use and after being wetted, the embossed features often collapse, thus changing the appearance of the paper product. The use of a patterned belt during paper making, may provide formed features in the resulting paper which are longer lasting wherein the fibrous structure better maintains its structural integrity when the fibrous structure product is wetted during use.

The present invention unexpectedly provides a fibrous structure product comprising formed features that change appearance upon wetting in use, thus providing consumers with a positive visual impression or signal of the performance of the product including the highly-absorbent nature of the product.

### SUMMARY OF THE INVENTION

In one embodiment, a fibrous structure product, is provided, comprising: a continuous first pillow region, a plurality of discrete densified regions having an area of from about 0.002 in² to about 0.015 in²; wherein at least some of the plurality of discrete densified regions have an inner perimeter forming a boundary defining at least one discrete second pillow region comprising an area of from about 5% to about 75% of the area of the discrete densified region.

In another embodiment, a fibrous structure product, is provided, comprising: a continuous first densified region; a plurality of discrete pillow regions having an area of from about 0.002 in² to about 0.015 in²; wherein at least some of the plurality of the discrete pillow regions have an inner perimeter forming a boundary defining at least one discrete second densified region comprising an area of from about 5% to about 75% of the area of the discrete pillow region.

### BRIEF DESCRIPTION OF THE DRAWINGS

FIG. 1A is a fragmentary top view of an exemplary embodiment of a product according to the present invention.

FIG. 1B is a cross-sectional view of the product of FIG. 1A taken along line 1B-1B.

FIG. 2A is a fragmentary top view of an exemplary embodiment of a product according to the present invention.

FIG. 2B is a cross-sectional view of the product of FIG. 2A taken along line 2B-2B.

FIG. 3A is a photograph of a top view of an exemplary embodiment of a product according to the present invention.

FIG. 3B is a photograph of a top view of the product for FIG. 3A after being wetted.

FIG. 4A is a photograph of a top view of an exemplary embodiment of a product according to the prior art.

FIG. 4B is a photograph of a top view of the product for FIG. 4A after being wetted.

FIG. 5A is a photograph of a top view of an exemplary embodiment of a product according to the prior art.

FIG. 5B is a photograph of a top view of the product for FIG. 5A after being wetted.

FIG. 6A is a fragmentary top view of an exemplary embodiment of a product according to the present invention.

FIG. 6B is a cross-sectional view of the product of FIG. 6A taken along line 6B-6B.

FIG. 7 is a fragmentary top view of an exemplary embodiment of a product according to the present invention.

### DETAILED DESCRIPTION OF THE INVENTION

“Paper product”, as used herein, refers to any fibrous structure product, which may, but not necessarily, comprise cellulose fibers. In one embodiment, the paper products of the present invention include tissue-towel paper products.

“Tissue-towel paper product”, as used herein, refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the fibers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

“Fibrous structure” as used herein means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process.

The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps may be used in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded.

In one embodiment the present invention may comprise a co-formed fibrous structure. A co-formed fibrous structure comprises a mixture of at least two different materials wherein at least one of the materials comprises a non-naturally occurring fiber, such as a polypropylene fiber, and at least one other material, different from the first material, comprising a solid additive, such as another fiber and/or a particulate. In one example, a co-formed fibrous structure comprises solid additives, such as naturally occurring fibers, such as wood pulp fibers, and non-naturally occurring fibers, such as polypropylene fibers.

Synthetic fibers useful herein include any material, such as, but not limited to polymers, such as those selected from the group consisting of polyesters, polypropylenes, polyethylenes, polyethers, polyamides, polyhydroxyalkanoates, polysaccharides, and combinations thereof. More specifically, the material of the polymer segment may be selected from the group consisting of poly(ethylene terephthalate), polybutylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or a mixture to make up the entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples of suitable bicomponent fibers are fibers made of copolymers of polyester (polyethylene terephthalate)/polyester (polyethylene terephthalate) otherwise known as “CoPET/PET” fibers, which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to make them more hydrophilic, more wettable, etc.

These multicomponent and/or synthetic fibers are further described in U.S. Pat. Nos. 6,746,766, 6,946,506, and 6,890,872; and U.S. Pat. Pub. Nos. 2003/0077444A1, 2003/0168912A1, 2003/0092343A 1, 2002/0168518A1, 2005/0079785A1, 2005/0026529A1, 2004/0154768A1, 2004/0154767, 2004/0154769A1, 2004/0157524A1, and 2005/0201965A1.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Embossing” or “embossments”, as used herein, refers to the process of deflecting a portion (e.g. a relatively small portion), of a cellulosic fibrous structure normal to its plane and impacting the projected portion of the fibrous structure against another surface, e.g. a relatively rigid surface, to permanently disrupt the fiber-to-fiber bonds. Exemplary methods of, and apparatus for, embossing are described in U.S. Pat. Pub. No. 2007/0062658A1 and U.S. Pat. Nos. 3,414,459, 4,320,162 and 5,468,323.

“Formed features”, as used herein, refers to surface features of a fibrous structure product that are formed during the papermaking process. In one embodiment the formed features comprise pillow regions, densified regions, and combinations thereof. In another embodiment formed features comprise a continuous first pillow region, a discrete densified region; a discrete second pillow region, a continuous first densified region, a discrete pillow region, a discrete second densified region, and combinations thereof. For example, these regions correspond to and are formed from the regions of the papermaking belt, for example, the pillow regions correspond to the deflection conduits of the papermaking belt and the densified regions correspond to the protuberances of the papermaking belt.

In one embodiment, the fibrous structure product herein having formed features has a pattern on the surface and molded into the fibrous structure product comprising densified regions and pillow regions. The densified regions of the cellulosic fibrous structure product are characterized by a relatively higher fiber density. The pillow regions of the fibrous structure are characterized as a high-bulk field of relatively lower fiber density (e.g. relative to the fiber density of the densified region). In an embodiment the cellulosic fibrous structure is macroscopically monoplanar and comprises two mutually orthogonal principle directions, a machine direction and a cross-machine direction and/or forming an X-Y plane and a Z-direction that is perpendicular to the X-Y plane. The fibrous structure further comprises a plurality of densified regions having a first density, and a plurality of pillow regions having a second density different from and less than the first density of the densified regions, the pillow regions comprising fibers molded generally perpendicular to said two mutually orthogonal principal directions.

In an embodiment the pillow regions appear to be protuberances when viewed from one surface of the ply of product and cavities when viewed from the opposite surface of the ply of product. In an embodiment the pillow regions are semi-continuous, continuous, discontinuous, or discrete and correspond to the deflection conduits of the papermaking belt from which they are formed. In an embodiment the densified regions are continuous or semi-continuous, discontinuous or discrete, are macroscopically monoplanar, and form a preselected pattern corresponding to the protuberances of the papermaking belt from which they are formed. Fibrous structure products and papermaking belts that form these fibrous structure products having continuous or semi continuous densified regions and discrete pillow regions are disclosed in U.S. Pat. Nos. 6,358,594; 5,628,876; 5,628,876; 6,193,847; 6,660,129. Densified regions of fibrous structure products that are discontinuous or discrete and pillow regions that are continuous or semi-continuous are disclosed in U.S. Pat. Nos. 4,637,859; 5,843,270; 5,820,730.

In an embodiment the pillow region may completely encircle the densified regions to isolate one densified region from another. In an embodiment the densified region may completely encircle the pillow regions to isolate one pillow region from another. The pillow regions may be dispersed throughout the whole of the densified region.

In an embodiment the densified region has a first basis weight and the pillow region has a second basis weight, wherein the first basis weight is different from and/or lower than the second basis weight.

The fibrous structure of this invention may be made by the steps of:

(a) Providing an aqueous dispersion of papermaking fibers; (b) Forming an embryonic web of papermaking fibers from the aqueous dispersion on a first foraminous member; (c) Associating the embryonic web with a second foraminous member. The second foraminous member or belt comprises a patterned framework of protuberances (or knuckles) and a reinforcing structure. The reinforcing structure of the belt has two opposed major surfaces. One major surface is the paper contacting side and from which the protuberances extend. The other major surface of the reinforcing structure of the papermaking belt is the backside, which contacts the machinery employed in a typical papermaking operation. Deflection conduits form in the belt between the protuberances. This belt has one surface (the embryonic web-contacting surface) comprising a macroscopically monoplanar network surface of protuberances which are continuous, semicontinuous, discontinuous, and/or discrete, and patterned (e.g. which forms the densified regions). Also defined within the second foraminous member or belt is a plurality of discrete, discontinuous, continuous, or semicontinuous deflection conduits (e.g. the deflection conduits forming the pillow regions) formed between the protuberances of the belt; (d) Deflecting the papermaking fibers in the embryonic web into the deflection conduits and removing water from the embryonic web through the deflection conduits so as to form an intermediate web of papermaking fibers; (e) Drying the intermediate web to form a fibrous structure product.

In an embodiment, the second foraminous member (e.g. deflection member) used to make the fibrous structure herein must be foraminous. That is to say, it must possess continuous passages connecting its first surface (or “upper surface” or “working surface”; i.e. the surface with which the embryonic web is associated, sometimes referred to as the “embryonic web-contacting surface”) with its second surface (or “lower surface”). Stated in another way, the deflection member must be constructed in such a manner that when water is caused to be removed from the embryonic web, as by the application of differential fluid pressure, and when the water is removed from the embryonic web in the direction of the foraminous member, the water can be discharged from the system without having to again contact the embryonic web in either the liquid or the vapor state.

Second, the embryonic web-contacting surface of the deflection member may comprise a macroscopically monoplanar, patterned, network surface. This network surface must define within the deflection member a plurality of continuous, semicontinuous, discrete, isolated, or discontinuous deflection conduits. The network surface may be “macroscopically monoplanar.” As indicated above, the deflection member may take a variety of configurations such as belts, drums, flat plates, and the like. When a portion of the embryonic web-contacting surface of the deflection member is placed into a planar configuration, the network surface is essentially monoplanar. It is said to be “essentially” monoplanar to recognize the fact that deviations from absolute planarity are tolerable, but not preferred, so long as the deviations are not substantial enough to adversely affect the performance of the product formed on the deflection member.

Additional examples of products, methods and apparatus for making product having formed features are described in U.S. Pat. Nos. 3,301,746, 3,974,025, 4,191,609, 4,637,859, 3,301,746, 3,821,068, 3,974,025, 3,573,164, 3,473,576, 4,239,065, and 4,528,239.

In another embodiment, formed features of a fibrous structure product may be formed from an aqueous slurry of papermaking fibers. An exemplary method for making a fibrous structure product having formed features is described as follows: A cellulosic fibrous web is formed at a low fiber consistency on a foraminous member to a differential velocity transfer zone where the web is transferred to a slower moving member such as a loop of open weave fabric to achieve wet-microcontraction of the web in the machine direction without precipitating substantial macrofolding or compaction of the web; and, subsequent to the differential velocity transfer, drying the web without overall compaction and without further material rearrangement of the fibers of the web in the plane thereof. The paper may be pattern densified by imprinting a fabric knuckle pattern into it prior to final drying; and the paper may be creped after being dried. Also, primarily for product caliper control, the paper may be lightly calendared after being dried. In an embodiment of the process the differential velocity transfer is achieved without precipitating substantial compaction (i.e., densification) of the web. Thus, the web is said to be wet-microcontracted as opposed to being wet-compacted or macro-folded or the like. The resulting fibrous structure has one or more plies of fibrous structure wherein at least one of the plies comprises two or more planes formed during the papermaking process wherein each plane is discontinuous from the other planes and wherein at least one of the planes comprises a continuous region.

### Fibrous Structure Product

In one embodiment, a fibrous structure product comprises a plurality of formed features wherein the formed features comprise a plurality of densified regions having a first surface area and a plurality of pillow regions having a second surface area wherein the first surface area is adjusted relative to the second surface area to provide better relative visual contrast between the regions. It is surprisingly discovered that the formed features of the present invention provide a different and improved appearance over products in the prior art when the product is wetted. Without wishing to be limited by theory, it is thought that upon wetting the pillow region has capacity to absorb a relatively higher amount of liquid compared to the densified region due to the greater amount of void space in the pillow regions. Also without wishing to be limited by theory, the present fibrous structure product provides a stronger change in relative contrast between pillow regions and densified regions due to different absorption levels between pillow regions and densified regions.

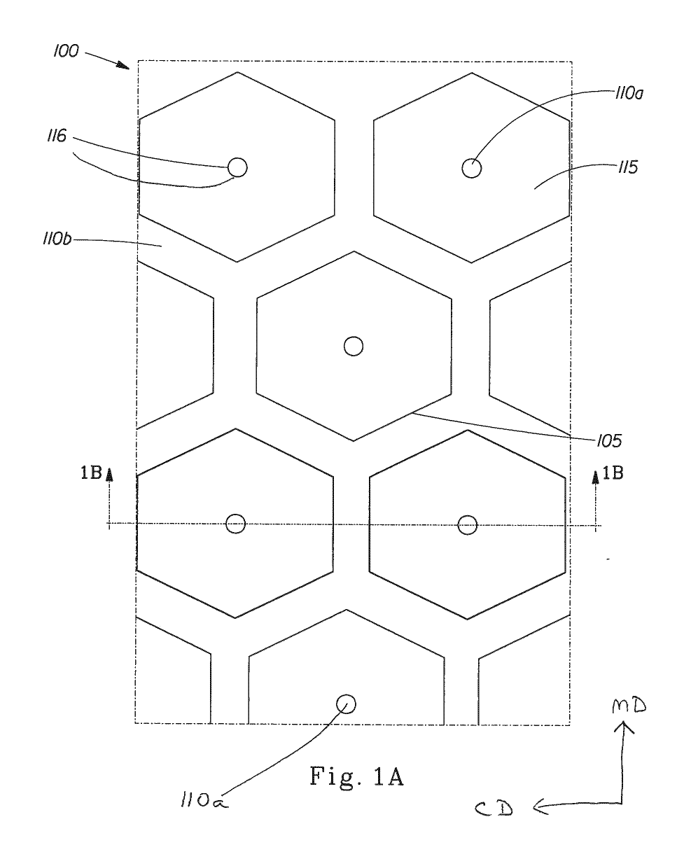

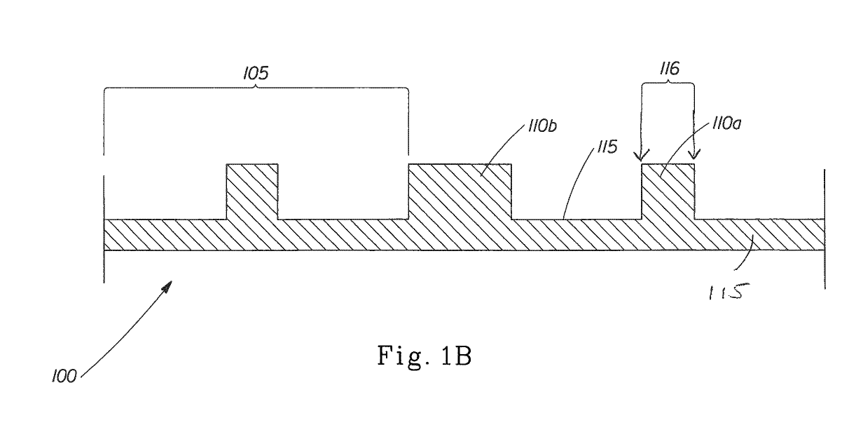

A nonlimiting example of a ply of a fibrous structure product 100 in accordance with the present invention is shown in FIG. 1A. As shown in FIG. 1A a fragmentary top view of a ply of a cellulosic fibrous structure product 100 comprises a plurality of formed features 105. In the exemplary embodiment, the formed features 105 comprise a plurality of discrete densified regions 115 and one or more discrete second pillow regions 110a. In the exemplary embodiment of FIG. 1A, the discrete densified regions 115 are surrounded by a continuous first pillow region 110b. In some embodiments, at least some of the discrete densified regions 115 have an inner perimeter 116. In other words, at least some of the discrete densified regions 115 may have an inner perimeter 116 forming a boundary in the MD-CD plane defining at least one discrete second pillow region 110a. In an embodiment the inner perimeter 116 forms discontinuity in the discrete densified region. FIG. 1B shows an exemplary embodiment of a cross-sectional view of the fibrous structure product 100 of FIG. 1A taken along the line 1B-1B. In an alternative embodiment to 1B, the pillow regions may appear to be protuberances when viewed from one surface of the ply of product and cavities when viewed from the opposite surface of the ply of product.

In one embodiment the discrete densified regions have an area A_{ddr} of from about 0.002 in² to about 0.015 in², in another embodiment, the A_{ddr} is from about 0.003 in² to about 0.01 in² and in yet another embodiment is from about 0.001 in² to about 0.009 in². If the discrete densified region comprises a discrete second pillow region within its boundary, then the area of the discrete densified region includes the area of the discrete second pillow region. If the discrete densified region comprises more than one discrete second pillow region within its boundary, then the area of the discrete densified region includes the area of all of the discrete second pillow regions within that discrete densified region.

In one embodiment, the discrete second pillow region has an area A_{dspr} of from about 5% to about 75%, of the area of the discrete densified region. In one embodiment, the discrete second pillow region has an area A_{dspr} of from about 6% to about 65% or about 7% to about 60% of the area of the discrete densified region.

In an embodiment the frequency of the discrete densified region is from about 5 to about 15 per linear inch, in another embodiment from about 6 to about 10 per linear inch, of the fibrous structure product.

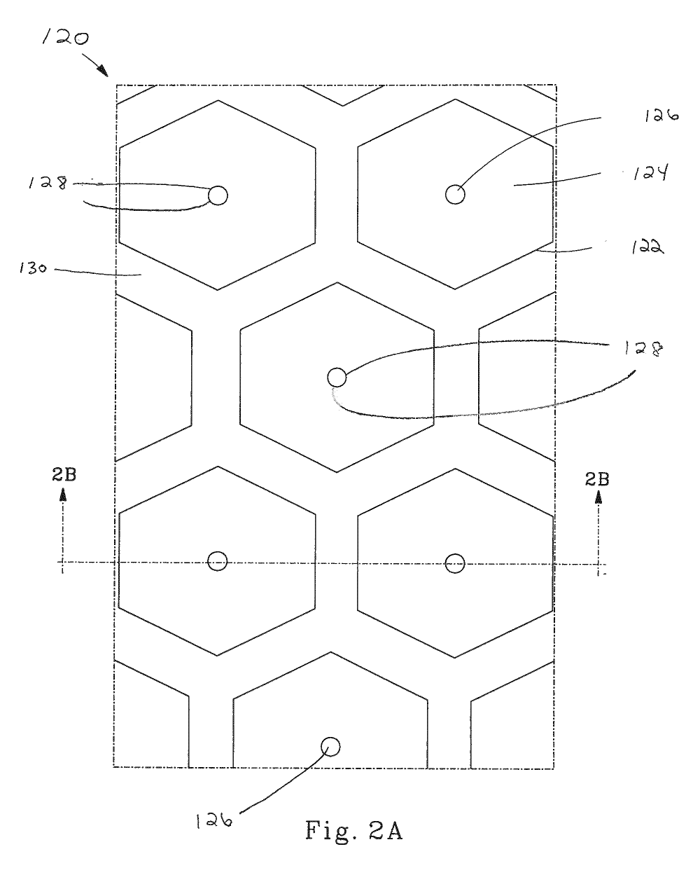

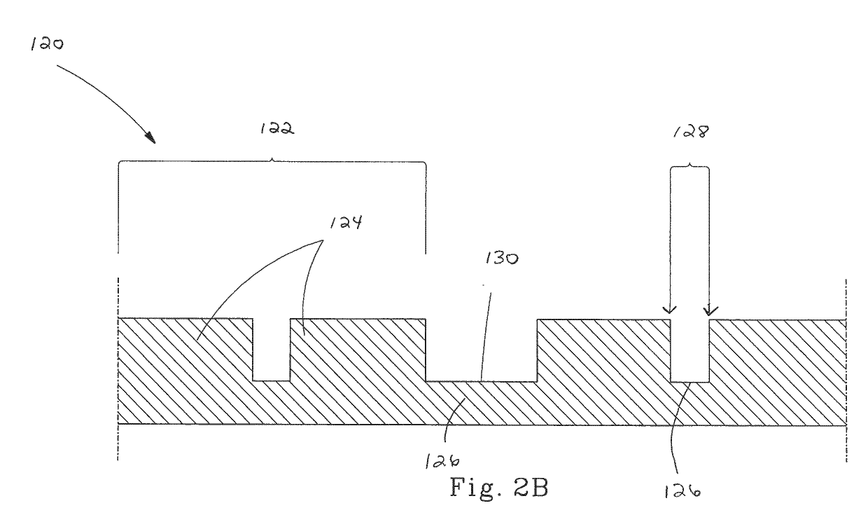

Another nonlimiting example of a ply of a fibrous structure product 120 in accordance with the present invention is shown in FIG. 2A. As shown in FIG. 2A a fragmentary top view of a ply of a cellulosic fibrous structure product 120 comprising a plurality of formed features 122. In the exemplary embodiment, the formed features 122 comprise discrete pillow regions 124 and one or more discrete second densified regions 126. In some embodiments, the discrete pillow regions 124 may form an inner perimeter 128. In other words, the discrete pillow regions 124 may form a continuous area in the MD-CD plane with an empty area (i.e., a discontinuity in the discrete pillow region) within the inner perimeter 128 of the discrete pillow regions 124. In the exemplary embodiment, the empty area (formed by the inner perimeter of the discrete pillow region) is occupied by a discrete second densified region 126. In the exemplary embodiment of FIG. 2A, the discrete pillow regions 124 are surrounded by a continuous first densified region 130. FIG. 2B shows an exemplary embodiment of a cross-sectional view of the fibrous structure paper product 120 of FIG. 2A taken along the line 2B-2B. In an alternative embodiment to 2B, the pillow regions may appear to be protuberances when viewed from one surface of the ply of product and cavities when viewed from the opposite surface of the ply of product.

In one embodiment the discrete pillow regions 124 have an area A_{dpr} of from about 0.002 in² to about 0.015 in². In another embodiment, the discrete pillow regions 124 have an area A_{dpr} of from about 0.003 in² to about 0.01 in². In another embodiment still, the discrete pillow regions 124 have an area A_{dpr} of from about 0.001 in² to about 0.009 in². If the discrete pillow region comprises a discrete second densified region within its boundary, then the area of the discrete pillow region includes the area of the discrete second densified region. If the discrete pillow region comprises more than one discrete second densified region within its boundary, then the area of the discrete pillow region includes the area of all of the discrete second densified regions within that discrete densified region.

In one embodiment, the discrete second densified region 126 has an area A_{dsdr}, of from about 5% to about 75% of the area of the discrete pillow region 124. In one embodiment, the discrete second densified region 126 has an area A_{dsdr} of from about 6% to about 65% and/or from about 7% to about 60% of the area of the discrete pillow region 124.

In an embodiment the frequency of the discrete pillow regions is from about 5 to about 15 per linear inch, in another embodiment from about 5 to about 10 per linear inch, of the fibrous structure product.

Exemplary papermaking belts which can make structures having continuous first pillow regions, discrete densified regions, discrete second pillow regions, continuous first pillow regions, discrete pillow regions, and discrete second densified regions are disclosed in U.S. Pat. Nos. 5,556,509 and 5,245,025. However, it was surprisingly discovered that by providing a sufficiently sized discrete second pillow region and/or discrete second densified region, the resultant fibrous structure product provides a enhanced visual signaling effect that is not present with incorrectly sized discrete second pillow regions and/or incorrectly sized discrete second densified regions.

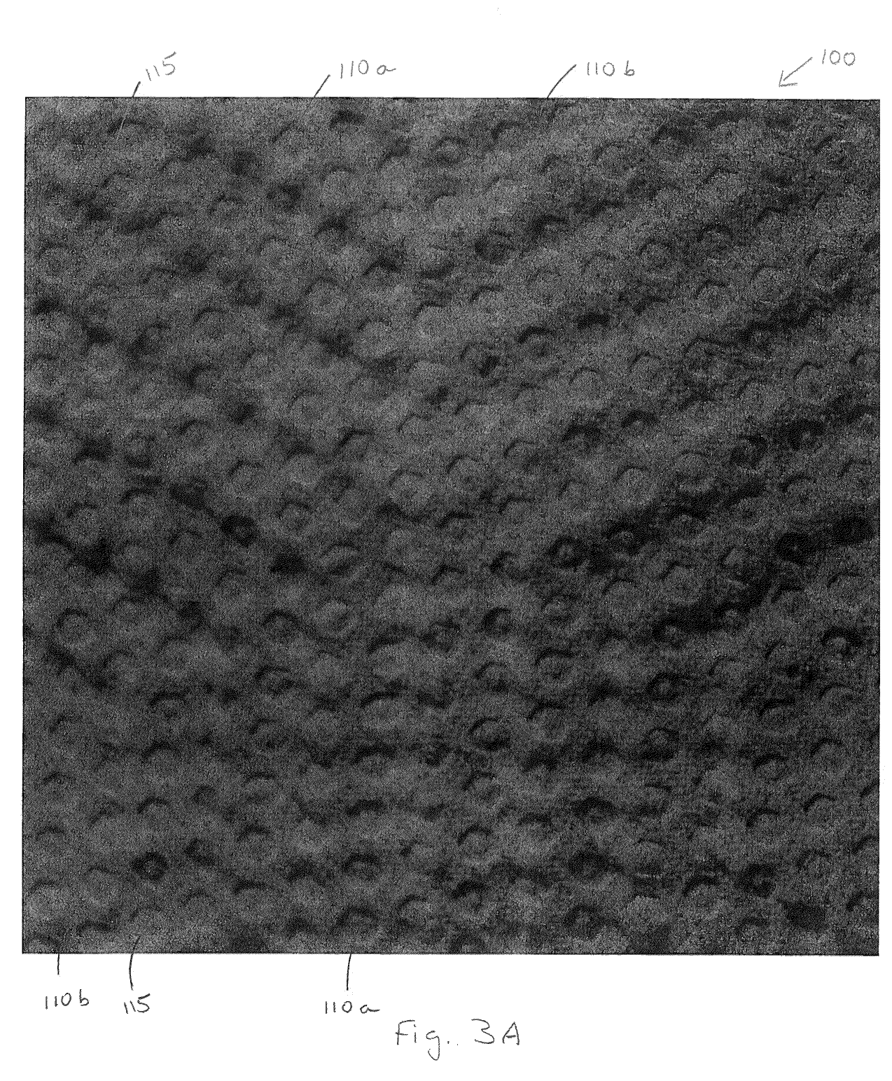

FIGS. 3A and 3B show an exemplary embodiment of the fibrous structure product 100 of 1A and 1B. FIG. 3A shows the fibrous structure product 100 of FIG. 1A in the dry state. The dry fibrous structure product is then wet according to the Wetting Test Method disclosed herein. FIG. 3B shows the fibrous structure product of 3A after wetting via the Wetting Test Method.

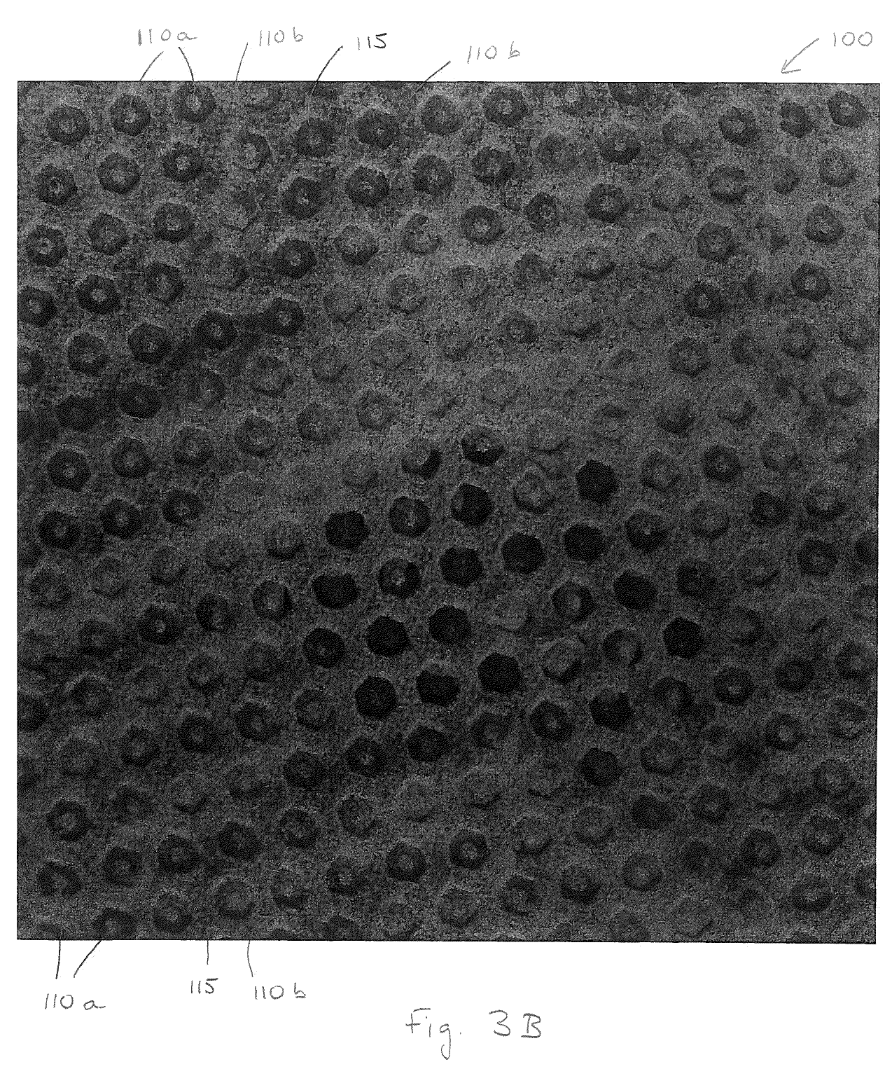

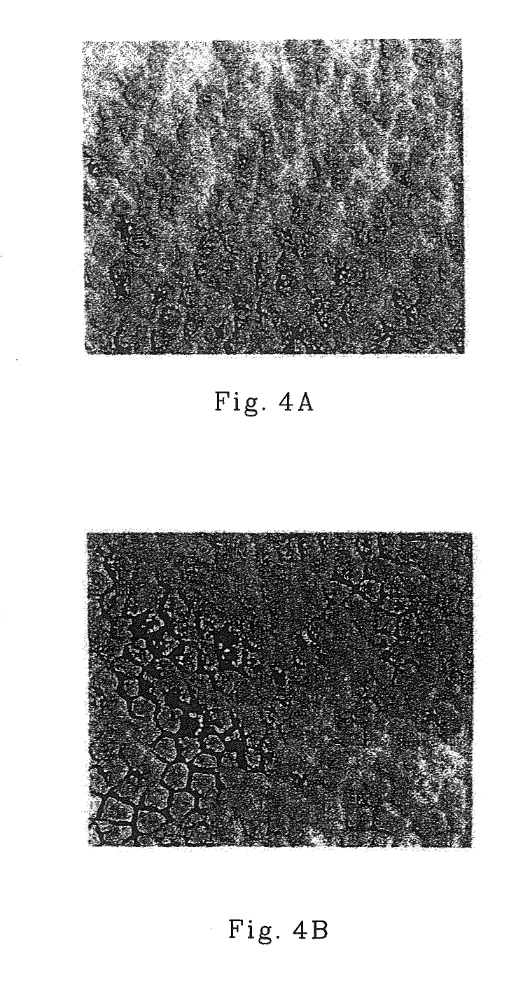

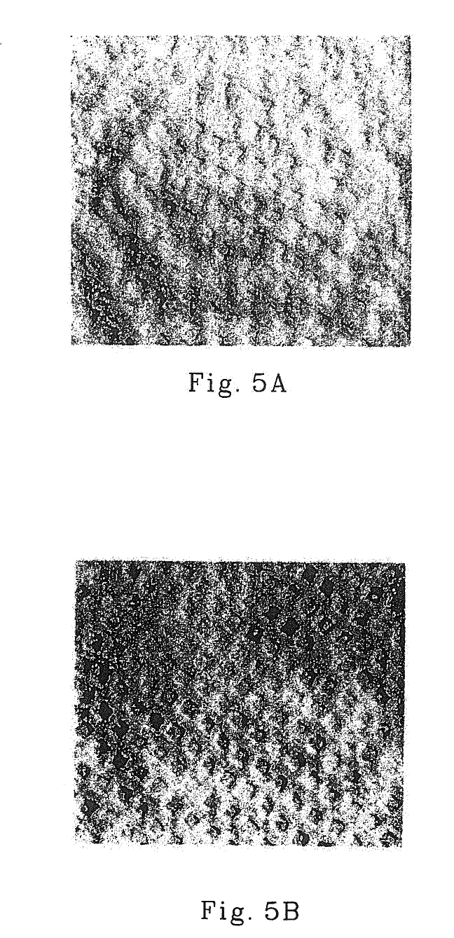

FIGS. 4A and 4B and FIGS. 5A and 5B show exemplary embodiments of prior art product before, and after, they have been wet according to the Wetting Test Method. FIG. 4A is a dry prior art product. FIG. 4B is the same product as 4A after wetting via the Wetting Test Method. FIG. 5A is a dry prior art product. FIG. 5B is the same product as 5A after wetting via the Wetting Test Method.

The product of FIGS. 3A-B shows a relatively clear change in appearance between the two products wherein the discrete second pillow region is visually enhanced or has greater visual contrast after wetting. The prior art products do not show an appreciable change in appearance. Without wishing to be limited by theory, it is thought that if the discrete second pillow regions in FIGS. 3A and 3B are incorrectly sized in relationship to the area of the discrete densified regions, there will not be a visually perceptible difference or enhanced contrast upon wetting. Further, it is thought that if the formed features (the discrete densified region and the discrete second pillow region) are each incorrectly sized, it will be difficult for a consumer to visually perceive a difference in the product upon wetting.

Again without wishing to be limited by theory, it is thought that if the discrete second densified regions in FIGS. 2A and 2B are too large in relationship to the area of the discrete pillow region, there will not be a visually perceptible difference or an enhanced contrast upon wetting. Further, it is thought that if the formed features (the discrete pillow region and the discrete second densified region) are each too large, it will be difficult for a consumer to visually perceive a difference in the product upon wetting.

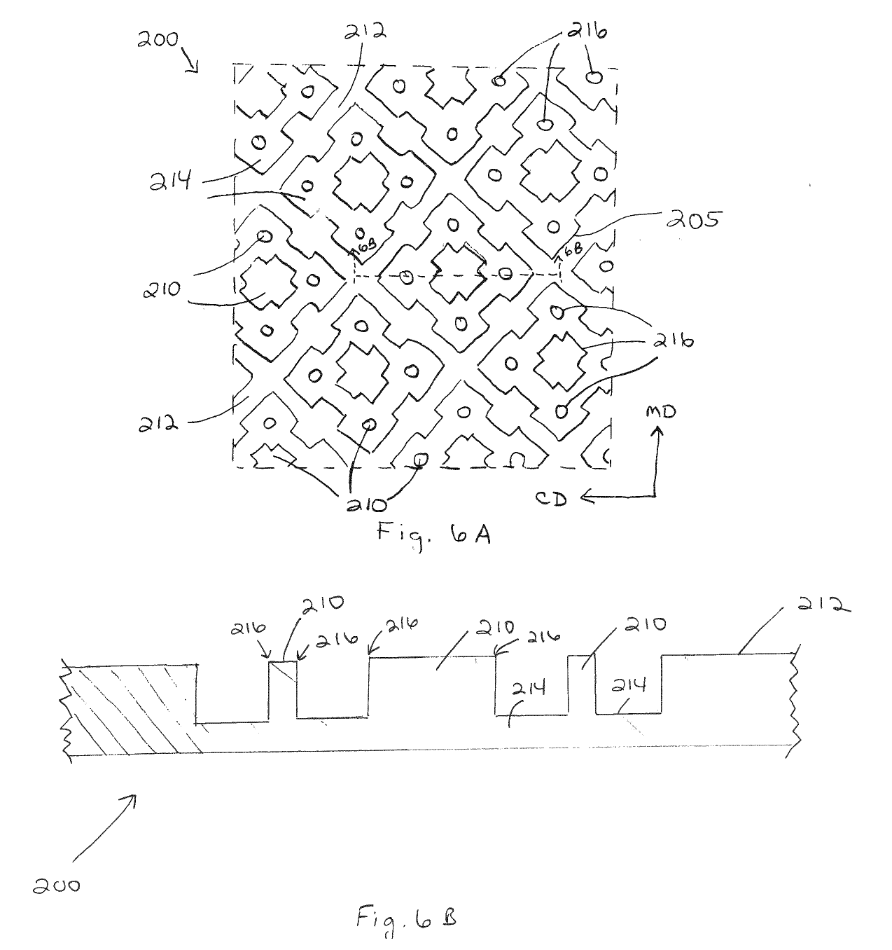

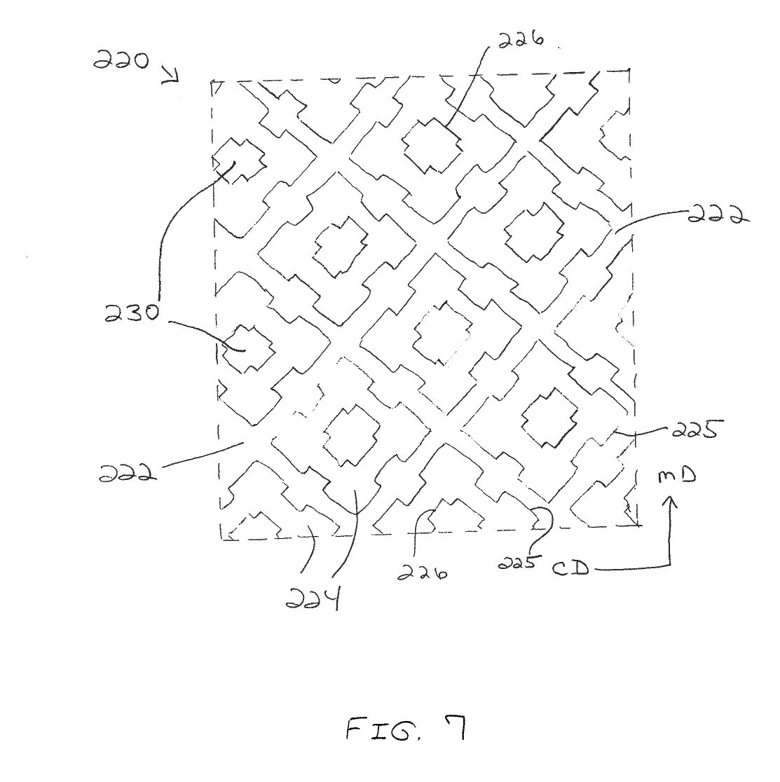

A nonlimiting example of another ply of a fibrous structure product 200 in accordance with the present invention is shown in FIG. 6A. As shown in FIG. 6A a fragmentary top view of a ply of a cellulosic fibrous structure product 200 comprises a plurality of formed features 205. In the exemplary embodiment, the formed features 205 comprise a plurality of discrete densified regions 214 and one or more discrete second pillow regions 210. In this embodiment the discrete densified region 214 comprises a plurality of discrete second pillow regions 210, for example FIG. 6A shows 5 discrete second pillow regions 210 within each discrete densified region. In the exemplary embodiment of FIG. 6A, the discrete densified regions 214 are surrounded by a continuous first pillow region 212. In some embodiments, at least some of the discrete densified regions 214 have a plurality of inner perimeters 216. In other words, at least some of the discrete densified regions 214 may have one or more, in another embodiment from about 2 to about 10, in another embodiment from about 2 to about 6, inner perimeters 216 forming a boundary in the MD-CD plane defining at least one, in another embodiment from about 2 to about 10, in another embodiment from about 2 to about 6, discrete second pillow regions 210. In an embodiment the inner perimeters 216 form discontinuity in the discrete densified regions 214.

FIG. 6B shows an exemplary embodiment of a cross-sectional view of the fibrous structure product 200 of FIG. 6A taken along the line 6B-6B. As shown in FIG. 6B a fragmentary top view of a ply of a cellulosic fibrous structure product 200 comprises a plurality of formed features. In the exemplary embodiment, the formed features comprise a plurality of discrete densified regions 214 and one or more discrete second pillow regions 210. In this embodiment the discrete densified region 214 comprises a plurality of discrete second pillow regions 210, for example FIG. 6B shows a plurality of discrete second pillow regions 210. In the exemplary embodiment of FIG. 6B, the discrete densified regions 214 are surrounded by a continuous first pillow region 212. In some embodiments, at least some of the discrete densified regions 214 have a plurality of inner perimeters 216. In other words, at least some of the discrete densified regions 214 may have one or more inner perimeters 216 forming a boundary in the MD-CD plane defining at least one discrete second pillow regions 210. In an embodiment the inner perimeters 216 form discontinuity in the discrete densified regions 214.

In one embodiment the discrete densified regions 214 have an area A_{ddr} of from about 0.002 in² to about 0.015 in², in another embodiment, the A_{ddr} is from about 0.003 in² to about 0.01 in² and in yet another embodiment is from about 0.001 in² to about 0.009 in². In one embodiment, the discrete second pillow regions have an area A_{dspr} of from about 5% to about 75%, of the area of the discrete densified regions 214. In one embodiment, the discrete second pillow region 210 has an area A_{dspr} of from about 6% to about 65% of the area of the discrete densified regions 214. In one embodiment, the discrete second pillow region 210 has an area A_{dspr} of from about 7% to about 60% of the area of the discrete densified regions 214. In an embodiment the total of all of the discrete second pillow regions within a single discrete densified region, have an area of from about 5% to about 75%, and/or from about 6% to about 65% and/or about 7% to about 60%, of the area of the discrete densified region 214.

A nonlimiting example of another ply of a fibrous structure product 220 in accordance with the present invention is shown in FIG. 7. As shown in FIG. 7 a fragmentary top view of a ply of a cellulosic fibrous structure product 220 comprises a plurality of formed features 226. In the exemplary embodiment, the formed features 226 comprise a plurality of discrete densified regions 224 and one or more discrete second pillow regions 230. In this embodiment the discrete densified region 224 comprises one or more discrete second pillow regions 230. In the exemplary embodiment of FIG. 7, the discrete densified regions 224 are surrounded by a continuous first pillow region 222. In some embodiments, at least some of the discrete densified regions 224 have a plurality of inner perimeters 226. In other words, at least some of the discrete densified regions 224 may have one or more inner perimeters 226 forming a boundary in the MD-CD plane defining at least one discrete second pillow regions 230. In an embodiment the inner perimeters 226 form discontinuity in the discrete densified regions 224.

### Paper Product

The present invention is equally applicable to all types of consumer paper products such as paper towels, toilet tissue, facial tissue, napkins, and the like.

The fibrous structure product may comprise any tissue-towel paper product known in the industry. Embodiment of these substrates may be made according U.S. Pat. Nos. 4,191, 4,300, 4,191,609, 4,514,345, 4,528,239, 4,529,480, 4,637,859, 5,245,025, 5,275,700, 5,328,565, 5,334,289, 5,364,504, 5,527,428, 5,556,509, 5,628,876, 5,629,052, 5,637,194, and 5,411,636; EP 677612; and U.S. Pat. Pub. No. 2004/0192136A1.

The tissue-towel substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. Nos. 6,048,938, 5,942,085, 5,865,950, 4,440,597, 4,191,756, and 6,187,138.

Conventionally pressed tissue paper and methods for making such paper are known in the art, for example U.S. Pat. No. 6,547,928.

Uncompacted, non pattern-densified tissue paper structures are also contemplated within the scope of the present invention and are described in U.S. Pat. Nos. 3,812,000, 4,208,459, and 5,656,132. Uncreped tissue paper as defined in the art are also contemplated. The techniques to produce uncreped tissue in this manner are taught in the prior art. For example, Wendt, et al. in European Patent Application Nos. 0 677 612A2 and 0 617 164 A1.

Uncreped tissue paper, in one embodiment, refers to tissue paper which is non-compressively dried, by through air drying. Resultant through air dried webs may be pattern densified such that zones of relatively high density are dispersed within a high bulk field, including pattern densified tissue wherein zones of relatively high density may be continuous and the high bulk field may be discrete, for example, European Patent Application Nos. 0 677 612A2 and 0 617 164 A 1; and U.S. Pat. No. 5,656,132.

Other materials are also intended to be within the scope of the present invention as long as they do not interfere or counteract any advantage presented by the instant invention.

The fibrous structure of the present invention may be cellulosic, non-cellulosic, or a combination of both. The fibrous structure may be conventionally dried using one or more press felts or through-air dried. If the fibrous structure which comprises the paper according to the present invention is conventionally dried, it may be conventionally dried using a felt which applies a pattern to the paper as taught in U.S. Pat. No. 5,556,509 and PCT App. No. WO 96/00812. The fibrous structure which comprises the paper according to the present invention may also be through air dried. A suitable through air dried substrate may be made according to U.S. Pat. No. 4,191,609.

In one embodiment, the fibrous structure product has a basis weight of from about 10 lbs/3000 ft² to about 50 lbs/3000 ft². In another embodiment the basis weight is from about 13 lbs/3000 ft² to about 40 lbs/3000 ft²; in another embodiment the basis weight is from about 20 lbs/3000 ft² and about 35 lbs/3000 ft², and in another embodiment the basis weight is from about 20 lbs/3000 ft² and about 30 lbs/3000 ft².

### Test Methods

The following describe the test methods utilized by the instant application in order to determine the values consistent with those presented herein.

### Wetting Test Method

One ply of the paper towel product is placed on a laminate countertop or similar non-absorbent surface with pillow regions oriented upward at SATP. About 0.5 ml of water is applied drop-wise to a single area of the towel surface using a 1 mL VWR transfer micropipette (Drummond Scientific, San Francisco, Calif.). The micropipette is held approximately 1 inch above the surface of the towel and the drops are applied at a rate of approximately 1 drop/sec. For the purposes of the present application, images are taken of the paper towel products within 1 minute of being wetted using this method.

### Method to Determine Area of Regions

The surface topography of dry samples is measured with a GF Messtechnik Mikrocad optical surface profiler (Teltow, Germany). The profiler has a field of view of 27 mm×21 mm and measures topography using the structured light projection technique. The sample size is at least the size of the profiler field of view and the continuous regions are oriented upward.

Topography data is analyzed by processing with a combination of the GFM ODSCAD software and a script written in Mathworks MatLab software (Natick, Mass., USA).

ODSCAD Processing. All topography maps are processed within the ODSCAD 6.0E software by 1) applying the Remove Invalid Points function to remove spurious data points, 2) applying the polynomial subtraction function (order 8, ignore the majority of the high level data, 5 iterations) to remove bulk sample curvatures and 3) exporting into the GFM FD3 v1.0 file format.

MATLAB Processing. All exported FD3 topography maps are analyzed using MatLab 2009b by the following steps. 1) The topography maps are imported into MatLab with a file reader script. This produces in MatLab an array of height data that can be processed like an image, i.e. a height image, of size 1280×1010 pixels. 2) The topography image is lightly smoothed with a 7×7 median filter. 3) The bottom surface of the sample is determined by sorting all height values and discarding the lowest 5% of the data. The bottom surface is the lowest value of the remaining data. The top surface is determined by discarding the upper 5% of the data and setting the top surface to the highest remaining value. A reference level for area measurements is determine to be 70% of the depth from the top to bottom surface. 4) The topography map is segmented at the reference level, those points below set to zero, those points above set to 1.

Measure of Central Discrete Second Pillow Region or the Discrete Second Densified Region: The image of step 4) is further processed. A) Any connected area touching the edge of the image is set to zero (this eliminated all areas except the discrete second regions). B) A morphological closing (5×5 disk kernel) is performed to merge broken segments of the remaining discrete second pillow regions or discrete second densified regions and C) the areas of the resulting merged regions are measure using the regionprops method within MatLab. The area results are finally written to an Excel spreadsheet.

Measure of Discrete Densified Region or the Discrete Pillow Region: The image of step 4) is further processed. A) The image is inverted so that points set to zero were set to one and vice versa. B) Any connected area touching the edge of the image is set to zero (this eliminated partial high density areas). C) The second discrete pillow areas or the second discrete densified areas are filled by setting the values to 1 using the MatLab imfill(holes) method and D) the areas of the resulting filled discrete densified or discrete pillow connected regions measure using the regionprops method. The area results are finally written to an Excel spreadsheet.

### Example 1

One fibrous structure useful in the present invention is a through-air-dried (TAD), differential density structure. Such a structure may be formed by the following process.

A Fourdrinier, through-air-dried papermaking machine is run under the following conditions to produce fibrous structure products of the present invention. A wet-microcontracted fibrous structure product is produced herein, comprising the steps of: first forming an embryonic web from an aqueous fibrous papermaking furnish. A slurry of papermaking fibers is pumped to the headbox at a consistency of about 0.15%. The slurry or furnish of the web comprises sixty five percent (65%) northern softwood kraft (NSK) (i.e., long papermaking fibers) and thirty five percent (35%) eucalyptus (THK). A strength additive, Kymene 557H, is added to the furnish at a rate of about 20 pounds per ton (about 10 gms/kg). Kymene is a registered trademark of Hercules Inc, of Wilmington, Del. The web is then forwarded at a first velocity, V₁, on a carrier fabric to a transfer zone having a transfer/imprinting fabric. The water is partially removed from the wet web, by non-compressively removing water from the web to a fiber consistency of from about 10% to about 30%, immediately prior to reaching the transfer zone to enable the web to be transferred to the transfer/imprinting fabric at the transfer zone. Dewatering occurs through the Fourdrinier wire and is assisted by vacuum boxes. The wire is of a configuration having 41.7 machine direction and 42.5 cross direction filaments per cm, available from Asten Johnson known as a “786 wire”.

The web is then transferred to the transfer/imprinting fabric in the transfer zone without precipitating substantial densification of the web. The web is then forwarded, at a second velocity, V₂, on the transfer/imprinting fabric along a looped path in contacting relation with a transfer head disposed at the transfer zone, the second velocity being from about 5% to about 40% slower than the first velocity. Since the wire speed is faster than the transfer/imprinting fabric, wet shortening of the web occurs at the transfer point. Thus, the wet web foreshortening may be about 3% to about 15%.

The transfer/imprinting fabric also called a second foraminous member or belt comprises a patterned framework of protuberances (or knuckles) and a reinforcing structure. The patterned framework comprises a photosensitive resin. The reinforcing structure is a fluid-permeable, woven fabric and has two opposed major surfaces. One major surface is the paper contacting side and from which the protuberances extend. The other major surface of the reinforcing structure of the papermaking belt is the backside, which contacts the machinery employed in a typical papermaking operation. Deflection conduits form in the belt between the protuberances. This belt has one surface (the embryonic web-contacting surface) comprising a macroscopically monoplanar network surface of protuberances (of photopolymer resin) which are continuous, semicontinuous, discontinuous, and/or discrete, and patterned (e.g. which forms the densified regions of the fibrous structure). Also defined within the second foraminous member or belt is a plurality of discrete, discontinuous, continuous, or semicontinuous deflection conduits (e.g. the deflection conduits forming the pillow regions) formed between the protuberances of the belt.

The papermaking fibers in the embryonic web are deflected into the deflection conduits and water is removed from the embryonic web through the deflection conduits so as to form an intermediate web of papermaking fibers.

In an embodiment the patterned resin protuberances of the belt have a top surface area that corresponds to the area of the densified regions of the fibrous structure made therefrom. The resin protuberances may cover about 20% to about 50% of the surface area of the reinforcing structure of the transfer/imprinting fabric. The polymer resin is supported by and attached to the reinforcing structure. The reinforcing structure, for example, may have 27.6 machine direction and 11.8 cross direction filaments per cm. The photopolymer resin protuberances may rise about 0.3 mm to about 0.6 mm above the top surface of the reinforcing structure.

In an embodiment the transfer/imprinting fabric consists of a continuous, deflection conduit form by a patterned network of discrete photopolymer resin wherein the continuous deflection conduit forms a continuous first pillow region. The patterned network of discrete photopolymer resin forms discrete densified regions in the fibrous structure product. Discrete deflection conduits are formed within the central portion of the discrete photopolymer resin to form discrete second pillow regions of the fibrous structure product. The discrete densified regions of the fibrous structure product may have a surface area of about 0.002 in² to about 0.015 in² and the discrete second pillow regions may have, for example, an area of that is from about 5% to about 30% of the discrete densified region.

The web is then adhesively secured to a drying cylinder having a third velocity, V₃. Polyvinyl alcohol creping adhesive is used. The drying cylinder is operated at a range of about 145° C. to about 170° C. or about 157° C., and the dryer, Yankee hoods, are operated at about 200° C. to about 250° C. The web is then dried on the drying cylinder without overall mechanical compaction of the web. The web is then creped from the drying cylinder with a doctor blade, the doctor blade having an impact angle of from about 90 degrees to about 130 degrees. Thereafter the dried web is reeled at a fourth velocity, V₄, that is faster than the third velocity, V₃, of the drying cylinder.

The resulting paper may have a plurality of formed features corresponding to FIGS. 1A and 1B with a plurality of discrete densified regions. In an embodiment at least some of the discrete densified regions have one or more discrete second pillow regions within the area occupied by the discrete densified region.

### Example 2

The same papermaking process of Example 1 is employed with a different patterned belt. In this embodiment, the web contacting side of the transfer/imprinting fabric consists of a continuous, patterned network of photopolymer resin wherein the continuous patterned network resin forms a continuous first densified region in the fibrous structure product. Dispersed throughout the continuous patterned network resin are discrete deflection conduits. The discrete deflection conduits form the discrete pillow regions of the fibrous structure product. The discrete deflection conduits further comprise discrete protuberances of photopolymer resin within the center of the area of the discrete deflection conduits to form the discrete second densified regions of the fibrous structure product. The discrete pillow regions of the fibrous structure product may have a surface area of about 0.002 in² to about 0.015 in² and the discrete second densified regions may have, for example, an area of that is from about 5% to about 30% of the discrete pillow region.

The resulting paper has a plurality of formed features with discrete pillow regions and discrete second densified regions within the area occupied by the discrete pillow regions.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure product comprising:
a continuous first pillow region,
a plurality of discrete densified regions having an area of from about 0.002 in² to about 0.015 in²;
wherein at least some of the plurality of discrete densified regions have an inner perimeter forming a boundary defining at least one discrete second pillow region comprising an area of from about 5% to about 75% of the area of the discrete densified region.

2. The product of claim 1 wherein the area of the discrete densified region is from about 0.003 in² to about 0.01 in².

3. The product of claim 2 wherein the area of the discrete densified region is from about 0.001 in² to about 0.009 in².

4. The product of claim 1 wherein the area of the second pillow region is from about 6% to about 65% of the area of the discrete densified region.

5. The product of claim 4 wherein the area of the second pillow region is from about 7% to about 60% of the area of the discrete densified region.

6. The product of claim 1 wherein the basis weight of the fibrous structure product is from about 10 lbs/3000 ft² to about 50 lbs/3000 ft².

7. The product of claim 6 wherein the basis weight is from about 20 lbs/3000 ft² to about 30 lbs/3000 ft².

8. The product of claim 1 wherein the frequency of the discrete densified region is from about 5 to about 15 per linear inch.

9. The product of claim 8 wherein the frequency of the discrete densified region is from about 6 to about 10 per linear inch.
